(19) United States
(12) Patent Application Publication
(10) Pub. No.: US 2009/0280946 A1
(43) Pub. Date: Nov. 12, 2009

(54) VEHICULAR DIFFERENTIAL GEAR APPARATUS

(75) Inventors: Yoshiki Matsuda, Toyota-shi (JP); Hiroshi Fujito, Seto-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Aichi-Ken (JP)

(21) Appl. No.: 12/436,491

(22) Filed: May 6, 2009

(30) Foreign Application Priority Data
May 7, 2008 (JP) 2008-121010

(51) Int. Cl. F16H 48/08

(52) U.S. Cl. 475/230

(57) ABSTRACT

A differential casing 36 is composed of a first divided case portion 46 and a second divided case portion 48 separated at a plane passing through the rotary axis C2 as a boundary. The first divided case portion 46 and the second divided case portion 48 are mutually joined in a state in which the divided mating surfaces 46a and 48a thereof are mated with each other. Thereby, a fastening bolt in parallel with the rotary axis C2 is not required, so that an interference with the head portion of the fastening bolt, a side bearing 30, and the bearing portion 44 of a differential carrier 16 is avoided. In this manner, the rotary axis C2 direction size of the differential gear apparatus 10 can be made small, and moreover, no slackening occurs between the two parts constituting the differential casing 36. Further, since the first divided case portion 46 and the second divided case portion 48 are the parts having the same shape, the manufacture and the parts management are made easy.

### CROSS-REFERENCE TO RELATED APPLICATIONS

This application claims priority of Japanese Patent Application No. 2008-121010 filed May 7, 2008.

### TECHNICAL FIELD

The present invention relates to a vehicular differential gear apparatus including a first divided case portion and a second divided case portion constituting a differential casing. In particular, the invention relates to a technique using no fastening member for mutually joining the first divided case portion and the second divided case portion, and yet removing slackening of both divided case portions.

### BACKGROUND ART

A differential gear apparatus is known, in which in a power transmission route from a driving source such as an engine to driving wheels of a vehicle, a driving force transmitted to an input member is distributed to a pair of output members while allowing a differential action between both the input member and the output member. For example, disclosed in Patent Document 1 (Japanese Utility Model Laid-Open No. 62-76727) is such differential gear apparatus.

In the vehicular differential gear apparatus, a differential casing includes a pair of first casing portion and second casing portion divided in a plane orthogonal to a rotary axis. These first and second casing portions are set in a mated state which accommodates therein a pinion located between a pair of differential side gears of being meshed with them and a support shaft member for rotatably supporting the pinion. In this state, the first and second casing portions are mutually joined by using a plurality of fastening members, for example, fastening bolts which are parallel with the rotary axis.

Now, in the conventional vehicular differential gear apparatus, a fastening bolt is used for joining the pair of first casing portions and second casing portions constituting the differential casing. Hence, there have been following three problems or troubles. In the first place, since side bearings and bearing portions of a housing fitted with the side bearings are unable to be radially enlarged for avoiding interference of a head of the fastening bolt with them, there is a limitation in making an axial dimension small. In the second place, due to the slackening of the fastening bolt, a load is concentrately applied to one of the first casing portion and the second casing portion to damage the durability thereof. In the third place, since the first casing portion and the second casing portion are not symmetrical in the shape, the two parts i.e., two different shaped parts are required, which makes a manufacture and parts management complicated.

### SUMMARY OF THE INVENTION

The present invention has been made on the background of the above described circumstances, and has a first object to provide a vehicular differential gear apparatus not requiring a plurality of fastening bolts parallel with a rotary axis for constituting the differential casing. Further, a second object of the invention is to provide a vehicular differential gear apparatus causing no slackening between the two parts constituting the differential casing.

The present inventor has found out, as a result of various investigations repeatedly conducted with the above described circumstances as the background, following fact. The differential casing is constructed by using the first divided casing and the second divided casing having a shape divided or separated at a plane passing through the rotary axis. These first and second divided casings are mutually joined by fitting them with a side gear and/or a ring gear. As a result, even when the fastening member constituting the differential casing is not used, the vehicular differential gear apparatus can be obtained without causing slackening between the two parts constituting the differential casing. The present invention has been made based on such knowledge.

In a first aspect of the present invention, a vehicular differential gear apparatus, comprises a differential casing in which a ring gear is fixed to an outer circumferential portion thereof, and both axial end portions thereof are rotatably supported in a housing around one axis through a pair of side bearings; a pair of side gears accommodated inside the differential casing and mutually opposing on the one axis; and a differential pinion accommodated inside the differential casing and rotatably supported around an axis orthogonal to the one axis to mesh with the pair of side gears. Here, the differential casing is constituted by mutually joining a first divided case portion and a second divided case portion separated at a plane passing through the one axis as a boundary.

In a second aspect of the present invention, the both axial end portions of the differential casing includes a pair of cylindrical fit-in surfaces fitted with the pair of side bearings, into which inner rings of the pair of side bearings are pushed, so that the pair of first divided case portion and second divided case portion are mutually joined.

In a third aspect of the present invention, the differential casing includes a cylindrical outer circumferential surface, at a central portion thereof in a direction of the one axis, fitted with the ring gear, into which the ring gear is pushed, so that the pair of first divided case portion and second divided case portion are mutually joined.

In a fourth aspect of the present invention 4, the differential casing includes a flange portion protruding radially outwardly from one axial end portion in a direction of the one axis of the cylindrical outer circumferential surface, to which the ring gear is fastened.

According to the vehicular differential gear apparatus of the first aspect, the differential casing is comprised of the first divided casing portion and the second divided casing portion which are separated or divided at the plane passing through one axis as the boundary and are mutually joined. Consequently, the plurality of fastening bolts in parallel with the rotary axis are not required. As a result, the interference of the head of the fastening bolt with the side bearing and the bearing portion of the housing fitted with the side bearing can be avoided, so that the axial dimension of the vehicular differential gear apparatus can be made small.

Further, the differential casing is constituted by mutually joining the first divided case portion and the second divided case portion which can be separated or divided at the plane passing through the one axis as the boundary. Consequently, the first divided casing portion and the second divided casing portion have the same shape, thereby making the manufacture and the parts management easy.

According to the second aspect, the both axial end portions of the differential casing includes the pair of cylindrical fit-in surfaces fitted with the pair of side bearings, into which inner rings of the pair of side bearings are pushed, so that the pair of first divided case portion and second divided case portion are mutually joined. Consequently, there is an advantage that not only no fastening member for mutually joining a pair of the first divided casing portion and the second divided casing portion is required at all, but no slackening occurs between the two parts constituting the differential casing.

According to the third aspect of the present invention, the differential casing includes the cylindrical outer circumferential surface, at a central portion thereof in a direction of the one axis, fitted with the ring gear, into which the ring gear is pushed, so that the pair of first divided case portion and second divided case portion are mutually joined. Consequently, there is an advantage that not only no fastening member for mutually joining the pair of the first divided casing portion and the second divided casing portion is required at all, but no slackening occurs between the two parts constituting the differential casing.

According to the fourth aspect of the present invention, the differential casing includes the flange portion protruding radially outwardly from one axial end portion in the direction of the one axis of the cylindrical outer circumferential surface, to which the ring gear is fastened. Consequently, there is an advantage that thanks to stronger joining of the ring gear to the differential casing, no further slackening occurs between the two parts constituting the differential casing.

### BRIEF DESCRIPTION OF THE DRAWINGS

FIG. 1 is a sectional view showing a final reduction gear including a vehicular differential gear apparatus according to one embodiment of the present invention;

FIG. 2 is a sectional view showing the vehicular differential gear apparatus and its peripheral parts of FIG. 1;

FIG. 3 is a view showing an external appearance of the vehicular differential gear apparatus of FIG. 2; and

FIG. 4 is a sectional view showing the final reduction gear including a conventional vehicular differential gear apparatus.

### DESCRIPTION OF THE PREFERRED EMBODIMENT

One embodiment of the present invention will be described in detail below with reference to the drawings. In the following embodiment, due to suitable simplification or deformation of the drawings, a dimension ratio, shape, and the like of each portion or parts are not necessarily represented accurately.

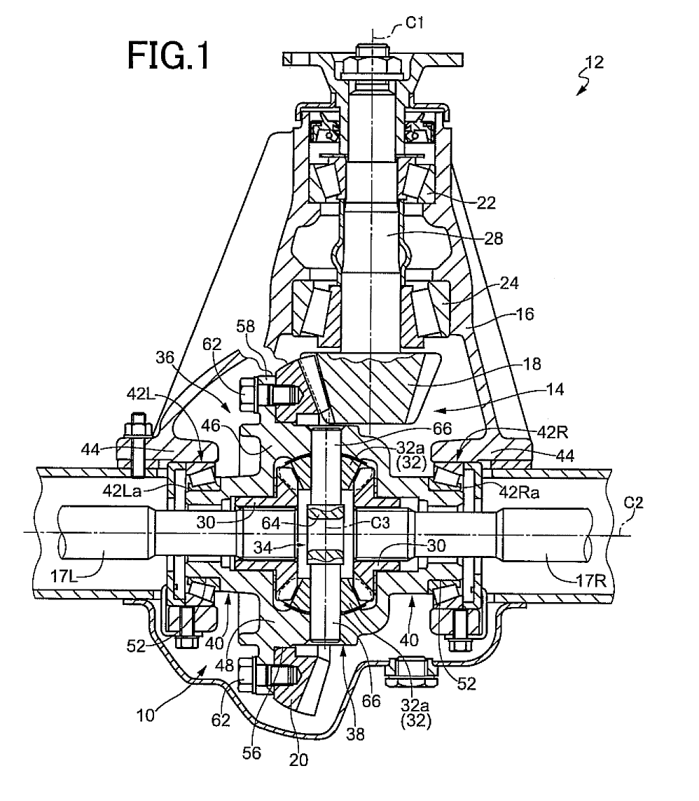

FIG. 1 is a sectional view showing a final reduction gear apparatus 12 including a vehicular differential gear apparatus 10 according to one embodiment of the present invention. In FIG. 1, the final reduction gear 12 includes the differential gear apparatus 10 and a reduction gear apparatus 14, and operates in a power transmission route from a driving source such as an engine to the left and right driving wheels, that is, the rear wheels (not shown). For example, by the final reduction gear 12, while a rotation inputted through a propeller shaft, i.e., an output shaft of the propeller shaft (not shown) is reduced, an inputted driving force is transmitted to the left and right driving wheels with a rotation speed difference allowed between both of the driving wheels. This final reduction gear 12 is suitably used for a FR (front engine rear drive) vehicle.

The differential gear apparatus 10 and the reduction gear apparatus 14, for example, are arranged inside a common differential carrier (housing) 16 mounted on the vehicle, and are configured to be lubricated by lubrication oil filled inside the differential carrier 16 by a predetermined quantity. FIG. 1 is a sectional view showing a rotary axis C1 of a driving shaft 28 to be described later and a rotary axis (one axis) C2 of a differential casing 36 to be described later within a common plane. The rotary axis C1 of the driving shaft 28 is coaxial with a rotary axis of the output shaft of the propeller shaft. The rotary axis (one axis) C2 of the differential casing 36 is coaxial with axes of driving shafts 17R and 17L coupled to the left and right driving wheels, respectively.

The reduction gear apparatus 14 has a well-known so-called speed reduction mechanism of a hypoid gear type, and includes a pair of speed reducing gears. That is, the reduction gear apparatus 14 includes in the power transmission route from the driving source to the driving wheels, a pair of hypoid gears composed of a drive pinion (reduction small gear) 18 located at upstream side, and a ring gear (reduction large gear) 20 located at downstream side to mesh with the drive pinion 18. The ring gear 20 has, as compared with the drive pinion 18, a large diameter and a large number of gears.

In the present embodiment, inside the differential carrier 16, the driving shaft 28 is rotatably supported by the differential carrier 16 through a pair of taper-roller bearings 22 and 24 around the rotary axis C1 coaxial with the rotary axis of the output shaft of the propeller shaft. The drive pinion 18 is integrally provided on the driving shaft 28 at one axial end thereof, and is configured to rotate around the rotary axis C1 together with the rotating driving shaft 28.

Further, the ring gear 20 meshed with the drive pinion 18 is fixed, of constituting members of the differential gear apparatus 10 to be described later, to an outer circumferential portion of the differential casing 36. By rotating the drive pinion 18, the ring gear 20 rotates in a direction orthogonal to the direction of the rotary axis C1 around the rotary axis C2 of the deferential casing 36 which is coaxial with the rotary axes of the left and right driving shafts 17R and 17L.

The differential gear apparatus 10 has a well-known so-called bevel gear type differential mechanism, and includes a pair of differential gears. That is, the differential gear apparatus 10 includes a pair of bevel gears composed of a pair of side gears 30 rotatably arranged around the rotary axis C2 and mutually opposed in the direction of the rotary axis C2, and a plurality of differential pinions 32 rotatably supported by a spider 34 around the rotary axial orthogonal to the rotary axis C2 in a state of being meshed with the pair of side gears 30. Further, the differential gear apparatus 10 includes, in addition to the pair of side gears 30, the plurality of differential pinions 32, and the spider 34, the differential casing 36 accommodating these parts therein.

The differential casing 36 has a central portion 38 and cylindrical end portions 40. The central portion 38 accommodates therein a pair of side gears 30, a plurality of differential pinions 32, and a spider 34, and extends in the direction of the rotary axis C2. The cylindrical end portions 40 are protruded axially from opening edges formed on the central portions 38 at both sides in the direction of the rotary axis C2. The both axial end portions 40 of the differential casing 36 inside the differential carrier 16 are rotatably supported by the differential carrier 16 through a pair of side bearings 42R and 42L composed of a pair of taper-roller bearings around the rotary axis C2.

The pair of side bearings 42R and 42L are fitted to inner circumferential surfaces of cylindrical bearing portions 44 integrally provided with the differential carrier 16 and extending axially inwardly in the direction of the rotary axis C2, at both sides sandwiching the central portion 38 of the differential casing 36 in the direction of the rotary axis C2.

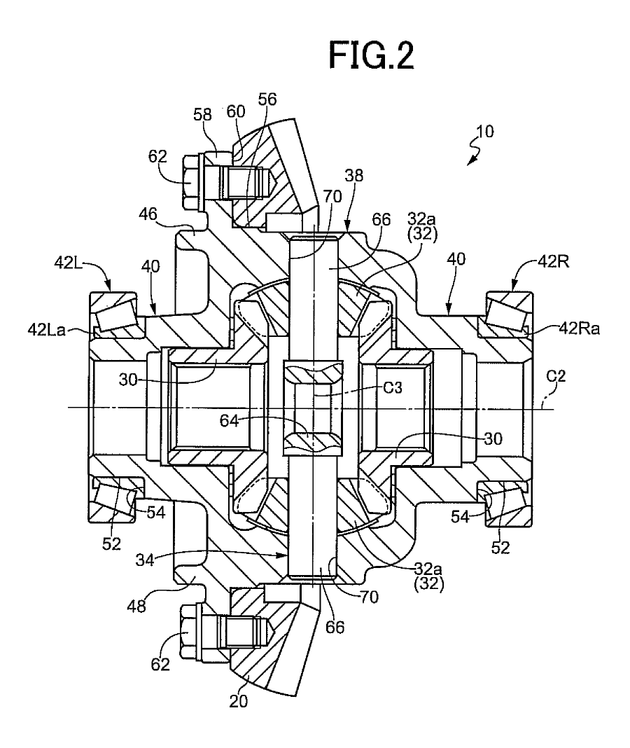

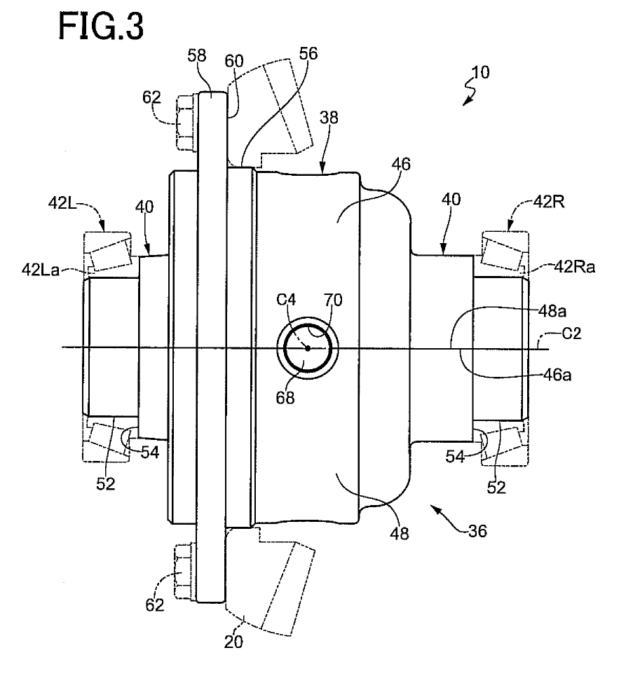

FIG. 2 is a longitudinal sectional view showing the differential gear apparatus 10 and its peripheral parts of FIG. 1, and FIG. 3 is a view showing an external appearance of the differential gear apparatus 10 of FIG. 2. In FIG. 3, the ring gear 20, a pair of side bearings 42R and 42L, and the like are shown by chain double-dashed lines for convenience.

In FIGS. 1 to 3, the differential casing 36 has a first divided case portion 46 and a second divided case portion 48 which can be separated at a plane passing through the rotary axis C2 as a boundary, and are mutually joined in a mated state in which divided mating surfaces 46a and 48a thereof are mated with each other. These first and second divided case portions 46 and 48 being composed of the parts mutually having the same shape, and are manufactured by shaping by the same mold by metal casting or metal sintering (powder metallurgy) and the like, and then being applied a predetermined surface grinding work.

In the present embodiment, the both end portions 40 of the differential casing 36 have axial top ends 51 formed into a stepped cylindrical shape of a small diameter, as compared with the root side, i.e., the central portion 38. The outer circumferential surfaces of both top ends 51 include a pair of cylindrical fit-in surfaces 52 fitted with the inner circumferential rings 42Ra and 42La of the pair of side bearings 42R and 42L, respectively. The first divided case portion 46 and the second divided case portion 48 are set in a mated state in which the divided mating surfaces 46a and 48a thereof are mated with each other. In this state, the inner rings 42Ra and 42La of the pair of side bearings 42R and 42L are pushed into the pair of cylindrical fit-in surfaces 52 provided at both end portions 40 in the direction of the rotary axis C2, respectively. In this manner, the first divided case portion 46 and the second divided case portion 48 are mutually joined.

Further, in the present embodiment, the inner rings 42Ra and 42La of the pair of side bearings 42R and 42L are pushed into until they are abutted against a pair of end surfaces 54 approximately orthogonal to the rotary axis C2, formed at a stepped position of the both end portions 40, respectively. Thus, the first divided case portion 46 and the second divided case portion 48 are mutual positioned in the direction of the rotary axis C2.

Further, in the present embodiment, the central portion 38 of the differential casing 36 is provided with a cylindrical outer circumferential surface 56 having an axial center C2 which is coaxial with the axial center of the cylindrical fit-in surface 52. This cylindrical outer circumferential surface 56 is provided with a cylindrical flange 58 protruding to the outer circumferential side i.e., radially outwardly from one axial end portion of the differential casing 36 in the rotary axis C2 direction. The first divided case portion 46 and the second divided case portion 48 are set in a state in which the divided mating surfaces 46a and 48a thereof are mated with each other. In this state, the ring gear 20 is pushed into the cylindrical outer circumferential surface 56 formed on the central portion 38, to mutually join the both divided case portions 46 and 48.

Further, in the present embodiment, the ring gear 20 is pushed into until it is abutted against an end surface 60 of the flange portions 58 which is approximately orthogonal to the rotary axis C2. Thereby, the first divided case portion 46 and the second divided case portion 48 are mutually positioned in the direction of the rotary axis C2. Further, the ring gear 20 is fastened to the flange portion 58 by a plurality of differential bolts 62 having axial axes in the direction parallel with the rotary axis C2 and penetrating through the flange portion 58.

Such differential casing 36 rotates around the rotary axis C2 together with the rotating ring gear 20 as the output member of the reduction gear apparatus 14 around the rotary axis C2.

The spider 34 rotatably supports a plurality of differential pinions 32 to be described later around respective axial axis. In the present embodiment, the spider 34 includes a joint cross composed of a cylindrical base portion 64, a pair of columnar shaft portions 66, and a pair of columnar shaft portions 68. The cylindrical base portion 64 is arranged approximately in the center of the central portion 38 of the differential casing 36, and has an axis coaxial with the rotary axis C2. The pair of columnar shaft portion 66 are protruded from an outer circumferential surface of the cylindrical base portion 64 in the direction of the axial axis C3 orthogonal to the rotary axis C2. The pair of columnar shaft portions 68 are protruded from the outer circumferential surface of the cylindrical base portion 64 in the direction of the axial axis C4 orthogonal to both the rotary axis C2 and the axial center C3.

This spider 34 has each top end of the pair of the shaft portions 66 and 68 fitted into each of four penetration holes 70 provided at equal intervals in the central portion 38 of the differential casing 36 in the circumferential direction around the rotary axis C2. By the rotation of the differential casing 36 around the rotary axis C2, the spider 34 rotates around the rotary axis C2 together with the differential casing 36.

The plurality of differential pinions 32 are accommodated inside the central portion 38 of the differential casing 36, and are rotatably supported by the pair of shaft portions 66 of the spider 34 around the axial center C3, being composed of a pair of differential pinions 32a and a pair of differential pinions 32b (not shown). The pair of differential pinions 32a mesh with a pair of side gears 30 to be described later in an opposing state on the axial center C3, respectively. The pair of differential pinions 32b is rotatably supported by the pair of the shaft portions 68 of the spider 34 around the axial center C4, and meshes with the pair of side gears 30 to be described later in an opposing state on the axial center C4, respectively.

These plural differential pinions 32 are rotated (autorotated) around the axial center C3 or C4 with rotation of the spider 34 and the differential casing 36 around the rotary axis C2. At the same time, the differential pinions 32 are rotated (revolved) together with the spider 34 and the differential case 36 around the rotary axis C2.

The pair of side gears 30 are accommodated inside the central portion 38 of the differential casing 36 in a state to be meshed with the plurality of differential pinions 32, respectively. The pair of side gears 30 are spline-fitted to the outer circumference of one end of the left and the right driving shafts 17R and 17L protruded into the central portion 38 of the differential casing 36 from both sides (left and right) in the direction of the rotary axis C2. The pair of side gears 30 have axes coaxial with the rotary axis C2, and are opposedly arranged on the rotary axis C2.

The pair of these side gears 30 rotates around the rotary axis C2 by the rotation of the plurality of differential pinions 32 around the rotary axis C2. Further, the left and right driving shafts 17R and 17L are coupled to one or the other of the pair of side gears 30 in a state of inhibiting relative rotation by the spline-fitting around the rotary axis C2. By rotating the coupled side gears 30 around the rotary axis C2, the left and right driving shafts 17R and 17L are rotated around the rotary axis C2 together therewith.

Upon driving the vehicle, the driving force is transmitted to the driving shaft 28 through the propeller shaft. The final reduction gear 12 configured as described above outputs this driving force to the left and right driving shafts 17R and 17L through the ring gear 20, the differential casing 36, the spider 34, the differential pinion 32, and the side gear 30 in this order. The differential gear apparatus 10 intermediately located in the transmission route distributes the driving force transmitted to the differential casings 36 as the input member to the pair of the side gears 30 as the pair of output members with allowing the differential action between them. That is, when the vehicle travels straightly, the plurality of differential pinions 32 rotate (revolve) around the rotary axis C2 together with the rotating differential casing 36 without rotating (autorotating) around the axial centers C3 or C4. Thereby, the pair of side gears 30 mutually rotate around the rotary axis C2 at the same rotation speed.

Further, when the vehicle is turning, the plurality of differential pinions 32 rotate (autorotate) around the axial centers C3 or C4, while rotating (revolving) around the rotary axis C2 together with the rotating differential casing 36. Thereby, the pair of side gears 30 rotate around the rotary axis C2 with a predetermined mutual rotation speed difference depending on magnitude of the turning radius of the vehicle, respectively.

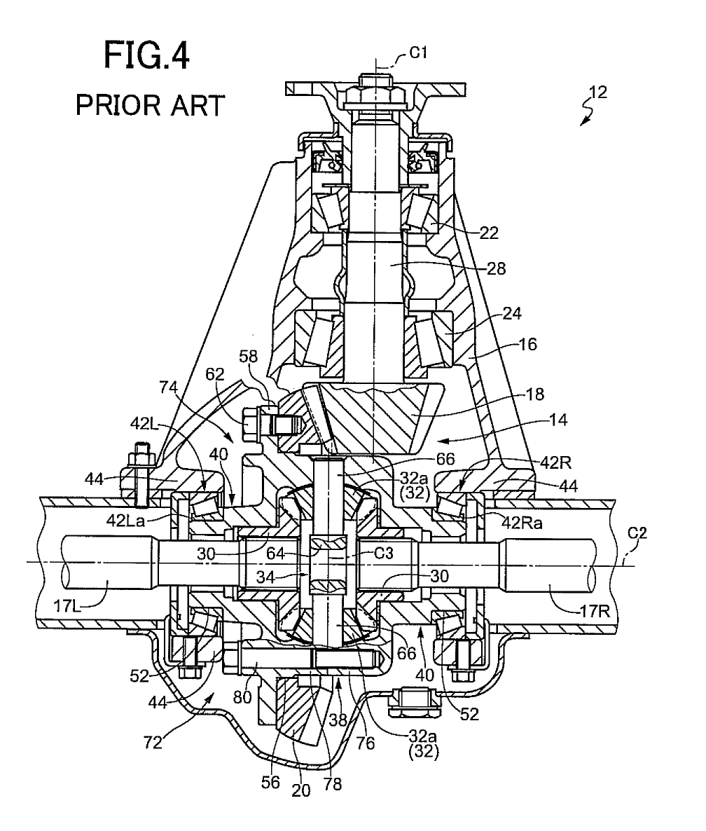

FIG. 4 is a sectional view showing the final reduction gear 12 including a conventional vehicular differential gear apparatus 72. A differential casing 74 of the conventional vehicular differential gear apparatus 72 has a pair of a first case potion 76 and a second case portion 78 divided at a plane orthogonal to the rotary axis C2 and passing through the axial center C3. These divided case portions are mutually joined by using a plurality of fastening bolts (fastening members) 80 parallel to the rotary axis C2. In the conventional vehicular differential gear apparatus 72 thus configured, when a side bearing 42L and a bearing portion 44 of a differential carrier 16 fitted with this side bearing are radially expanded or enlarged to improve the strength and the like, they will interference with the head of the fastening bolt 80. Hence, the side bearing 42L and the bearing portion 44 cannot be radially expanded, and the differential gear apparatus 72 is restricted in making dimension in the direction of the rotary axis C2 small.

Further, the conventional differential gear apparatus 72 has following two problems. In the first place, due to the slackening of the fastening bolt 80, a load is concentrately applied to one of the first case portion 76 and the second case portion 78 to damage the durability of the differential casing 74. In the second place, since the first case portion 76 and the second case portion 78 do not have a symmetrical shape, the two different shape parts are required, which makes the manufacture and the parts management complicated.

As described above, according to the vehicular differential gear apparatus 10 of the present embodiment, the differential casing 36 includes the first divided case portion 46 and the second divided case portion 48 separated at the plane passing through the rotary axis C2 as the boundary. These first and second divided case portions 46 and 48 are configured such that the divided mating surfaces 46a and 48a thereof are mutually joined in a mated state with each other. Consequently, the plurality of fastening bolts 80 parallel to the rotary axis C2 are not required. As a result, the interference of the head of the fastening bolt 80 with the side bearing 30 and the bearing portion 44 of the differential carrier (housing) 16 fitted with the side bearing 30 can be avoided. In this manner, size of the vehicular differential gear apparatus 10 in the direction of the rotary axis C2 can be made small.

Further, the differential casing 36 has the first divided case portion 46 and the second divided case portion 48 separated at the plane passing through the rotary axis C2 as the boundary mutually joined in a mated state in which the divided mating surfaces 46a and 48a thereof are mated with each other. Consequently, the first divided case portion 46 and the second divide case portion 48 have the same shape, to make the manufacture and the parts management easy.

Further, according to the vehicular differential gear apparatus 10 of the present embodiment, the both end portions 40 of the differential casing 36 include a pair of cylindrical fit-in surfaces 52 fitted with a pair of side bearings 30. The inner circumferential rings 42Ra and 42La of a pair of side bearings 42R and 42L are pushed into the pair of cylindrical fit-in surfaces 52, so that the pair of first divided case portion 46 and the second divided case portion 48 are mutually joined. Consequently, there is an advantage that not only any fastening bolt(s) for mutually joining the pair of first divided case portion 46 and the second divided case portion 48 is (are) not required at all, but no slackening occurs between the two parts 46 and 48 constituting the differential casing 36.

Further, in the present embodiment, the inner circumferential rings 42Ra and 42La of the pair of side bearings 42R and 42L are axially pushed into until they abut against a pair of end surfaces 54 approximately orthogonal to the rotary axis C2 at the stepped portions of both end portions 40, respectively. Thereby, the first divided case portion 46 and the second divided case portion 48 are mutually positioned in the direction of the rotary axis C2. Consequently, there is an advantage that the axial positioning of both divided case portions 46 and 48 is easy.

Further, according to the vehicular differential gear apparatus 10 of the present embodiment, the differential casing 36 includes the cylindrical outer circumferential surface 56 on the central portion 38 in the direction of the rotary axis C2, fitted with the ring gear 20. With the ring gear 20 pushed into the cylindrical outer circumferential surface 56, the pair of first divided case portion 46 and the second divided case portion 48 are mutually joined. Consequently, there is an advantage that no fastening member(s) for mutually joining the pair of first divided case portion 46 and second divided case portion 48 is required at all. In addition, no slackening occurs between the two parts 46 and 48 constituting the differential casing 36.

Further, in the present embodiment, the ring gear 20 is pushed into until it abuts against the end surface 60 of the flange portions approximately orthogonal to the rotary axis C2. Thereby, the first divided case portion 46 and the second divided case portion 48 are mutually positioned in the direction of the rotary axis C2. Consequently, there is an advantage that the axial positioning of both divided case portions is easy.

Further, according to the vehicular differential gear apparatus 10 of the present embodiment, the differential casing 36 includes the flange portion 58 protruding radially outwardly from one axial end portion of the cylindrical outer circumferential surface 56 in the direction of the rotary axis C2. The ring gear 20, fastened to the flange portion 58 by a differential bolt 62, is more firmly and strongly joined to the differential casing 36. Consequently, there is an advantage that no further slackening occurs between the two parts 46 and 48 constituting the differential casing 36.

Further, in the present embodiment, the ring gear 20 is pushed into until it abuts against the end surface 60 of the flange portions approximately orthogonal to the rotary axis C2. Thereby, the first divided case portion 46 and the second divided case portion 48 are mutually positioned in the direction of the rotary axis C2. In this manner, an abutted state of the ring gear 20 against the end surface 60 of the flange portion 58 through the fastening by the differential bolt 62 is maintained. As a result, a mutual shift between the first divided case portion 46 and the second divided case portion 48 in the direction to the rotary axis C2 is prevented.

While one embodiment of the present invention has been described in detail with reference to the drawings, the present invention is not limited to this embodiment, and can be also executed by other embodiments.

For example, in the above described embodiment, the reduction gear apparatus 14 was provided with a pair of hypoid gears transmitting the power between skew gears. However, being not limited to this, the reduction gear apparatus, for example, may be provided with a pair of straight bevel gears and a pair of spiral bevel gears transmitting the power between intersecting gears. Alternatively, a pair of helical gears and a pair of parallel gears transmitting the power between parallel axes suitably used in FF (front engine, front drive) vehicles and the like may be provided for the reduction gear apparatus.

Further, in the above described embodiment, the differential gear apparatus 10 was disposed in the power transmission route downstream the propeller shaft in the back side of the FR vehicle, and was arranged inside the final reduction gear 12 on the driving shafts 17R and 17L of the driving wheels, i.e., the rear wheels. However, being not limited to this, for example, the differential gear apparatus 10 may be provided inside the common housing together with a pair of transmission gears in the transmission of a transaxle type in the FF vehicle and the like and arranged on the driving shaft of the front wheels and the like. Further, the differential apparatus is not limited to one used for the left-right drive wheels of the vehicle, but may be one used for the members arranged in front-rear direction of the vehicle, such as a center differential and the like used in a four-wheels drive type vehicle. Thus, various types or kinds of the differential gear apparatus can be employed.

Thus described as above is only one embodiment. Although other examples are not explained one by one, the present invention can be executed in the configuration added with various revisions and improvements based on the knowledge of the person skilled in the art in the scope not departing from the spirit of the invention.

1. A vehicular differential gear apparatus, comprising:
a differential casing in which a ring gear is fixed to an outer circumferential portion thereof, and both axial end portions thereof are rotatably supported in a housing around one axis through a pair of side bearings;
a pair of side gears accommodated inside the differential casing and mutually opposing on the one axis; and
a differential pinion accommodated inside the differential casing and rotatably supported around an axis orthogonal to the one axis to mesh with the pair of side gears,
wherein the differential casing is constituted by mutually joining a first divided case portion and a second divided case portion separated at a plane passing through the one axis as a boundary.

2. The vehicular differential gear apparatus according to claim 1, wherein the both axial end portions of the differential casing includes a pair of cylindrical fit-in surfaces fitted with the pair of side bearings, into which inner rings of the pair of side bearings are pushed, so that the pair of first divided case portion and second divided case portion are mutually joined.

3. The vehicular differential gear apparatus according to claim 1, wherein the differential casing includes a cylindrical outer circumferential surface, at a central portion thereof in a direction of the one axis, fitted with the ring gear, into which the ring gear is pushed, so that the pair of first divided case portion and second divided case portion are mutually joined.

4. The vehicular differential gear apparatus according to claim 3, wherein the differential casing includes a flange portion protruding radially outwardly from one axial end portion in a direction of the one axis of the cylindrical outer circumferential surface, to which the ring gear is fastened.

5. The vehicular differential gear apparatus according to claim 2, wherein the differential casing has, at stepped portions of the end portions, a pair of end surfaces to which inner rings of the side bearings are abutted and which is orthogonal to the one axis.

6. The vehicular differential gear apparatus according to claim 2, wherein the flange portion has an end surface to which the ring gear is abutted and which is orthogonal to the one axis.
